(19) United States
(12) Patent Application Publication
(10) Pub. No.: US 2010/0272628 A1
(43) Pub. Date: Oct. 28, 2010

(54) Fabrication of Plate-Like Natural Crystalline Graphite with Nano-Scale Thickness

(75) Inventors: Byoung-Gon Kim, Daejeon (KR); Gye-Seung Lee, Daejeon (KR); Chong-Lyuck Park, Daejeon (KR); Ho-Seok Jeon, Daejeon (KR); Hee-Dong Jang, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: Korea Institute of Geoscience and Mineral Resources (KIGAM), Daejeon (KR)

(21) Appl. No.: 12/604,069

(22) Filed: Oct. 22, 2009

(30) Foreign Application Priority Data
Apr. 22, 2009 (KR) 10-2009-0035132

(51) Int. Cl. C01B 31/04

(52) U.S. Cl. 423/448

(57) ABSTRACT

Provided is a method for preparing plate-like ultrafine particles of flaky graphite having an average graphite plate diameter of 3-5 μm and a graphite plate thickness of 20-60 nm, including: grinding natural flaky graphite to control the particle size to 5-15 μm; dipping the ground flaky graphite into an aqueous solution containing an acid and an oxidizing agent, followed by washing and drying, to form a graphite intercalation compound in the ground flaky graphite; carrying out gasification of the graphite intercalation compound via low-temperature heat treatment to expand the flaky graphite to 20-30%; and carrying out wet grinding of the expanded flaky graphite at a slurry concentration of 20-28 wt %.

The ultrafine particles of flaky graphite disclosed herein have a narrow particle size distribution, and maintain unique properties of flaky graphite due to the lack of interlayer collapse in flaky graphite particles.

The present invention claims priority of Korean Patent Application No. 10-2009-0035132, filed on Apr. 22, 2009, which is incorporated herein by reference.

### BACKGROUND OF THE INVENTION

1. Field of the Invention

The present invention relates to a method for preparing ultrafine particles of plate-like flaky graphite having an average graphite plate diameter of 3-5 μm and a graphite plate thickness of 20-60 nm.

2. Description of Related Art

Natural flaky graphite forms a plate-like layered structure in which carbon atoms form a hexagonal ring to provide sheets stacked in parallel with crystallographic C-axis. In such a layered structure, interlayer binding force is very weak, resulting in high mechanical brittleness.

Since graphite shows relatively high heat resistance and has a very low heat expansion coefficient as well as excellent heat conductivity and electroconductivity, it has been widely used in conductive paints, paints for LCD panels, paints for shielding electromagnetic waves, or the like. In addition, due to the excellent lubricability, graphite has been widely used in solid lubrication oil, oil for industrial instruments, etc. Particularly, graphite particles having higher crystallinity provide better properties, and thus have been utilized in various applications, including advanced materials. Therefore, when providing graphite as fine particles, it is required to prepare graphite suitable for particular use, considering crystallographic/structural characteristics of graphite.

Fine graphite particles have been frequently obtained through a vibration ball mill in a wet atmosphere. However, such a wet process requires a long processing time of 24 hours or more and a large amount of work energy. On the other hand, grinding in a dry atmosphere has many advantages. However, it is difficult to prepare fine graphite particles through a dry grinding process because of the lubricability of flaky graphite having a layered structure.

The shape of ground graphite particles is important for the particular use, because plate-like particles relatively well maintain electroconductivity and heat conductivity as well as lubricability. Therefore, it is required to reduce the size of graphite particles while maintaining their flake shapes during the grinding process.

### SUMMARY OF THE INVENTION

As mentioned above, conventional simple wet processes for preparing fine particles of flaky graphite require an undesirably long processing time and many operations, and conventional simple dry processes are not amenable to easy preparation of fine particles of flaky graphite. Therefore, an embodiment of the present invention is directed to providing a method for preparing plate-like ultrafine particles of flaky graphite with a nano-scaled thickness by subjecting natural flaky graphite to low expansion and grinding it under a wet condition while inducing exfoliation of graphite particles.

To achieve the object of the present invention, the present invention provides a method for preparing plate-like ultrafine particles of flaky graphite having an average graphite plate diameter of 3-5 μm and a graphite plate thickness of 20-60 nm, including:

grinding natural flaky graphite to control the particle size to 5-15 μm;

dipping the ground flaky graphite into an aqueous solution containing an acid and an oxidizing agent, followed by washing and drying, to form a graphite intercalation compound in the ground flaky graphite;

carrying out gasification of the graphite intercalation compound via low-temperature heat treatment to expand the flaky graphite to 20-30%; and

carrying out wet grinding of the expanded flaky graphite at a slurry concentration of 20-28 wt %.

The ultrafine particles of flaky graphite disclosed herein have a plate-like shape and a nano-scaled thickness. As used herein, the average graphite plate diameter means the average diameter of the surface perpendicular to C-axis of the ultrafine particles of flaky graphite. The graphite plate thickness means the thickness of a cluster. According to each operation of the method disclosed herein, it is possible to obtain plate-like ultrafine particles of flaky graphite with a nano-scaled thickness by subjecting natural flaky graphite to low expansion and grinding it under a wet condition while inducing exfoliation of graphite particles.

First, the grinding operation is carried out to allow natural flaky graphite to have the above range of particle sizes for the purpose of uniform expansion during the subsequent expansion operation. Such uniform expansion also allows uniform exfoliation in the following wet grinding operation.

In the aqueous solution into which the ground flaky graphite is dipped, particular non-limiting examples of the acid include sulfuric acid, and those of the oxidizing agents include hydrogen peroxide. Preferably, the aqueous solution includes 3-10 parts by weight of hydrogen peroxide and 5-50 parts by weight of water based on 100 parts by weight of sulfuric acid to perform the subsequent gasification of the graphite intercalation compound and low expansion.

Then, low-temperature heat treatment is carried out at 200-300° C. for 60-200 minutes. Through the low-temperature heat treatment, a graphite intercalation compound is gasified in flaky graphite, thereby inducing interlayer expansion of flaky graphite. The interlayer expansion means that expansion is performed in a cluster unit. According to one embodiment, it is possible to control the gasification rate of the graphite intercalation compound through the temperature and time of the heat treatment. Since the heat treatment is accomplished in the above range of times, it is possible to perform the expansion gradually, and thus to control the thickness and size of the particles of flaky graphite to a desired level. If the heat treatment is carried out for a time more than 200 minutes, it is difficult to satisfy the desired thickness, i.e., thickness along C-axis. If the heat treatment is carried out at a temperature higher than 300° C., rapid thermal impact is applied to the particles due to such a relatively high temperature, resulting in an increase in the gasification rate of the graphite intercalation compound and expansion degree thereof. As a result, it is not possible to accomplish uniform expansion.

As the expansion degree increases beyond the above-defined range, the resultant fine graphite particles become too soft to be ground smoothly. Therefore, according to the method disclosed herein, continuous heat treatment of the graphite intercalation compound is carried out at low temperature within the above-defined range of times so as to perform gradual gasification and to induce low expansion.

Such low expansion of flaky graphite to a degree of 20-40%, preferably 20-37% through the low-temperature heat treatment is distinguished from the conventional expansion process of flaky graphite through high-temperature heat treatment or low-expansion process under pressure. It is possible to obtain ultrafine particles of flaky graphite in a cluster unit while maintaining unique properties of graphite, only when the expansion degree is maintained in the above-defined range.

Such low-expansion through the low-temperature heat treatment is accomplished mainly in a cluster unit of flaky graphite. As used herein, the expression ‘accomplished in a cluster unit’ means that the expansion occurs mostly in a cluster unit rather than interlayer or inter-stack expansion. Since the expansion does not occur in a layer unit, it is possible to maintain unique properties of graphite and to obtain flaky graphite having the above-defined range of thicknesses. Such expansion in a cluster unit may occur slightly during the subsequent wet grinding operation as described in the following test example. Due to the lack of interlayer expansion, it is possible to maintain unique properties of flaky graphite.

In the wet grinding operation, grinding may be carried out under a slurry concentration controlled to 10-45 wt %, preferably 20-28 wt % to increase the grinding efficiency. The grinding efficiency refers to the yield of fine particles having an average graphite plate diameter of 3 μm or less. The slurry concentration affects the slurry fluidity and grinding efficiency.

According to another embodiment, the wet grinding operation is carried out by attrition milling. More particularly, the attrition milling may use an attrition mill. Attrition milling processes are different from vibration milling processes. In the case of vibration milling, continuous impact is applied to particles through vibration, thereby causing interlayer expansion of flaky graphite. If such interlayer expansion occurs, flaky graphite will undergo a change in its properties. In the method disclosed herein, attrition milling is used to cause exfoliation or grinding in a cluster unit. This is because attrition milling principle is mainly based on shear stress. Particularly, it is preferable to use attrition milling mainly based on shear stress because the expanded graphite suggested herein shows weak attraction force between graphite plates in a cluster unit.

To perform the attrition milling effectively during the wet grinding operation, flaky graphite, balls and water are used preferably in a ratio of 1:45-65:3-5 (flaky graphite: balls:water) in view of uniform grinding of particles to a desired size and thickness.

The attrition milling may be carried out at 500-700 rpm for 2-6 hours so that the particles are uniformly ground and maintain a plate-like shape in a cluster unit.

The method for preparing ultrafine particles of flaky graphite disclosed herein provides plate-like particles having a nano-scaled thickness of 20-60 nm as well as an average graphite plate diameter of 3 μm-5 μm. In addition, due to the lack of interlayer collapse of particles, it is possible to maintain unique properties of flaky graphite.

The method disclosed herein is effective for preparing ultrafine particles of flaky graphite while solving the above-mentioned problems of the conventional wet grinding and dry grinding processes. In addition, the above-described low-expansion of flaky graphite results in effective grinding into plate-like particles.

Further, the above-described attrition milling enables grinding in a cluster unit, and allows the resultant ultrafine particles of flaky graphite to have a narrow particle size distribution.

### BRIEF DESCRIPTION OF THE DRAWINGS

FIG. 1 is a schematic view illustrating an attrition mill used in the method in accordance with an embodiment of the present invention.

FIG. 2 is a photograph of natural flaky graphite in accordance with an embodiment of the present invention, as taken by scanning electron microscope (SEM).

FIG. 3 is a graph showing the volume increment (%) as a function of heat treatment temperature.

FIG. 4 is a graph showing the expanded volume increment (%) as a function of temperature for a heating time of 60 minutes during the heat treatment.

FIG. 5 is a graph showing the effect of the expansion ratio after heat treatment upon the size reduction efficiency.

FIG. 6 is a graph showing the grinding efficiency as a function of slurry concentration in Test Example.

FIG. 7 is a graph showing variations in crystallinity of flaky graphite particles as a function of grinding time as determined by X-ray diffraction (XRD).

FIG. 8 is a graph showing variations in particle size as a function of grinding time.

FIG. 9 is a photograph of ultrafine particles of flaky graphite obtained from Example 1, as taken by SEM.

FIG. 10 is a graph showing the particle size distribution according to Example 4.

### DESCRIPTION OF SPECIFIC EMBODIMENTS

The advantages, features and aspects of the invention will become apparent from the following description of the embodiments with reference to the accompanying drawings, which is set forth hereinafter.

The following Examples and Comparative Examples are carried out under the condition as shown in Table 1.

### Example 1

### Grinding Natural Flaky Graphite

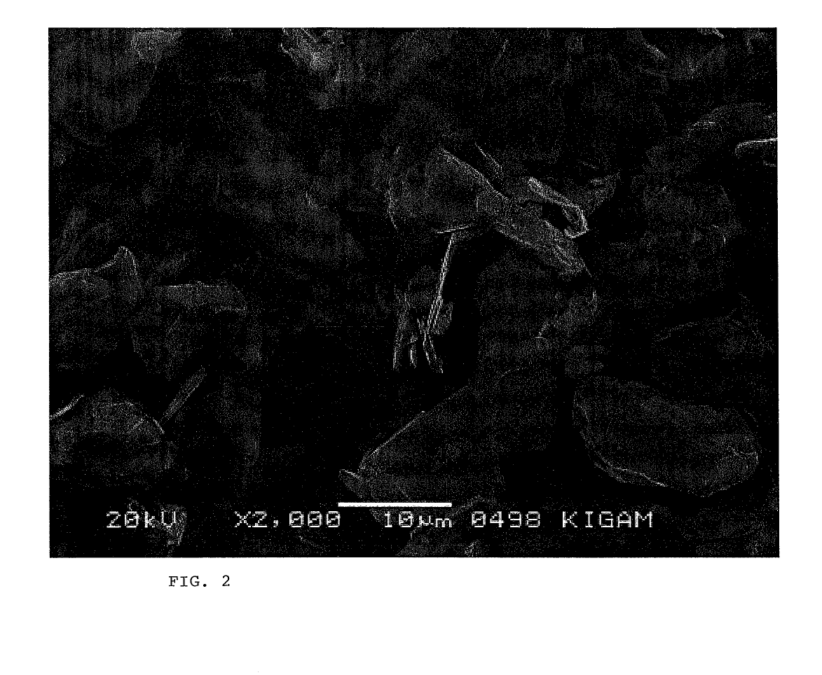

2,000 g of a natural flaky graphite sample having a fixed carbon content of 99% is ground by a jet mill to an average particle size of 10 μm. FIG. 2 is a photograph of the natural flaky graphite sample as taken by scanning electron microscope (SEM). The natural flaky graphite sample is mostly present in the form of small clusters having a small aspect ratio and a size of about 10 μm.

Forming Graphite Intercalation Compound

First, 18 moles of concentrated sulfuric acid and 35% aqueous hydrogen peroxide are mixed in a weight ratio of 5:1 to provide 1,500 g of an intercalant solution. Next, 1,500 g of the ground natural flaky graphite powder obtained as described above is introduced and dipped thereto for 1 hour, followed by washing with water, and then is dried in an oven at 100° C.

Expanding Flaky Graphite

1,400 g of flaky graphite containing the graphite intercalation compound therein as described above is subjected to heat treatment by heating it in an electric furnace at 250° C. for 60 minutes so that it is expanded.

Wet Grinding Expanded Flaky Graphite

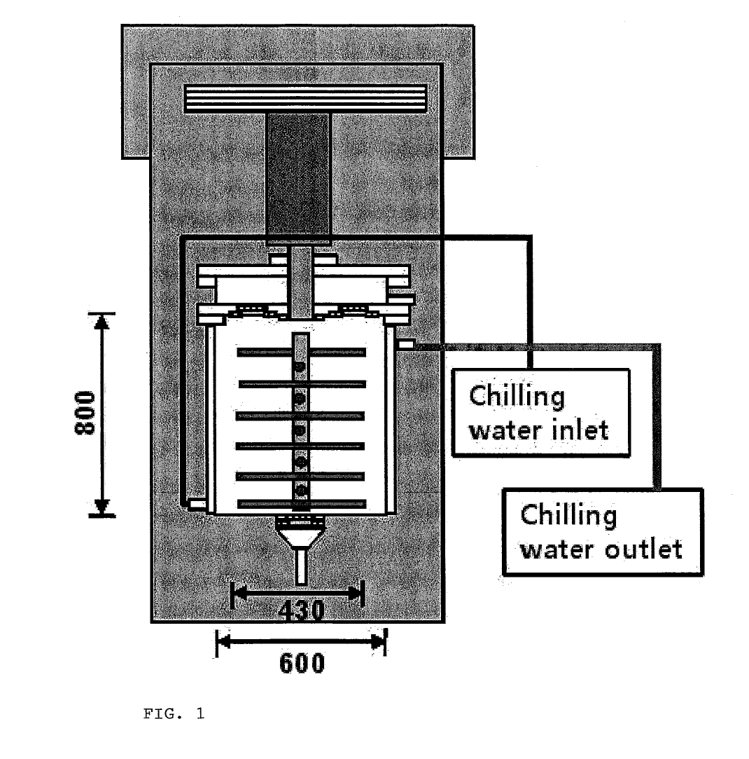

First, 1,250 g of the flaky graphite obtained as described above is mixed with 5 kg of water to a slurry concentration of 25 wt %. Next, the slurry is introduced into the grinding chamber of the self-produced attrition mill as shown in FIG. 1 together with 60 kg of stainless steel balls having a diameter of 3 mm so that the flaky graphite is ground. The attrition mill includes an 18 L grinding chamber, an agitator and a drive motor. The agitator has six arms (D (diameter) 20×L (length) 43) and rotates under the maximum speed of 600 rpm. Grinding is carried out for 2 hours under 600 rpm to obtain ultrafine particles of flaky graphite.

### Example 2

### Grinding Natural Flaky Graphite

Natural flaky graphite is ground in the same manner as described in Example 1.

Forming Graphite Intercalation Compound

A graphite intercalation compound is formed in the same manner as described in Example 1.

Expanding Flaky Graphite

Flaky graphite is expanded in the same manner as described in Example 1, except that the heat treatment is carried out at a temperature of 300° C.

Wet Grinding Expanded Flaky Graphite

The expanded flaky graphite is subjected to wet grinding in the same manner as described in Example 1.

### Example 3

### Grinding Natural Flaky Graphite

Natural flaky graphite is ground in the same manner as described in Example 1.

Forming Graphite Intercalation Compound

A graphite intercalation compound is formed in the same manner as described in Example 1.

Expanding Flaky Graphite

Flaky graphite is expanded in the same manner as described in Example 1, except that the heat treatment is carried out at a temperature of 200° C.

Wet Grinding Expanded Flaky Graphite

The expanded flaky graphite is subjected to wet grinding in the same manner as described in Example 1.

### Example 4

### Grinding Natural Flaky Graphite

Natural flaky graphite is ground in the same manner as described in Example 1.

Forming Graphite Intercalation Compound

A graphite intercalation compound is formed in the same manner as described in Example 1.

Expanding Flaky Graphite

Flaky graphite is expanded in the same manner as described in Example 1.

Wet Grinding Expanded Flaky Graphite

The expanded flaky graphite is subjected to wet grinding in the same manner as described in Example 1, except that the grinding is carried out for 6 hours.

### Comparative Example 1

### Grinding Natural Flaky Graphite

Natural flaky graphite is ground in the same manner as described in Example 1.

Forming Graphite Intercalation Compound

A graphite intercalation compound is formed in the same manner as described in Example 1.

Expanding Flaky Graphite

Flaky graphite is expanded in the same manner as described in Example 1, except that the heat treatment is carried out at a temperature of 400° C.

Wet Grinding Expanded Flaky Graphite

The expanded flaky graphite is subjected to wet grinding in the same manner as described in Example 1.

### Comparative Example 2

### Grinding Natural Flaky Graphite

Natural flaky graphite is ground in the same manner as described in Example 1.

Forming Graphite Intercalation Compound

A graphite intercalation compound is formed in the same manner as described in Example 1.

Expanding Flaky Graphite

Flaky graphite is expanded in the same manner as described in Example 1, except that the heat treatment is carried out at a temperature of 150° C.

Wet Grinding Expanded Flaky Graphite

The expanded flaky graphite is subjected to wet grinding in the same manner as described in Example 1.

### Comparative Example 3

### Grinding Natural Flaky Graphite

Natural flaky graphite is ground in the same manner as described in Example 1.

Forming Graphite Intercalation Compound

A graphite intercalation compound is formed in the same manner as described in Example 1.

Expanding Flaky Graphite

Flaky graphite is expanded in the same manner as described in Example 1, except that the heat treatment is carried out at a temperature of 100° C.

Wet Grinding Expanded Flaky Graphite

The expanded flaky graphite is subjected to wet grinding in the same manner as described in Example 1.

### Comparative Example 4

### Grinding Natural Flaky Graphite

Natural flaky graphite is ground in the same manner as described in Example 1.

Forming Graphite Intercalation Compound

A graphite intercalation compound is formed in the same manner as described in Example 1.

Expanding Flaky Graphite

Flaky graphite is expanded in the same manner as described in Example 1, except that the heat treatment is carried out at a temperature of 600° C.

Wet Grinding Expanded Flaky Graphite

The expanded flaky graphite is subjected to wet grinding in the same manner as described in Example 1.

### Test Example

The method in accordance with the present invention will be characterized by the following Test Example. The size, shape and crystallinity of particles are determined by a particle size analyzer (Later micron sizer LMS 30, Seishin), a scanning electron microscopy (SEM, JSM-6400, Phillips) and an X-ray diffractometer (MPD, Phillips). To determine the volume increment during the heat treatment, the density of particles is measured by a powder analyzer (PA-MC, Seishin) as a bulk density after tapping.

Determination of Volume Increment During Expansion of Flaky Graphite Depending on Heat Treatment Temperature

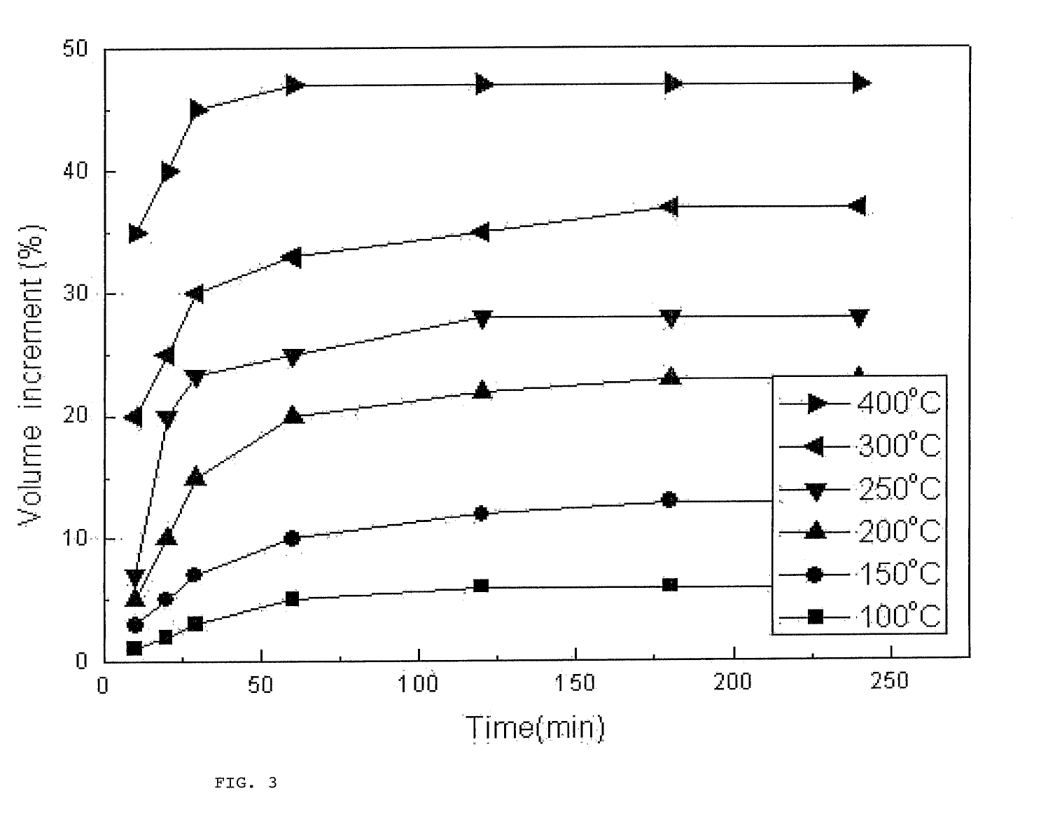

In Examples 1-3 and Comparative Examples 1-4, retention time in the electric furnace during the expansion of graphite is varied from 10 minutes to 240 minutes. After measuring the tapping density of the flaky graphite expanded under the condition of each Example, the density is expressed as a volume increment (%). To measure the density of the expanded flaky graphite, a powder analyzer (PA-MC, Seishin) is used and the bulk density after tapping is calculated. The results are shown in FIG. 3.

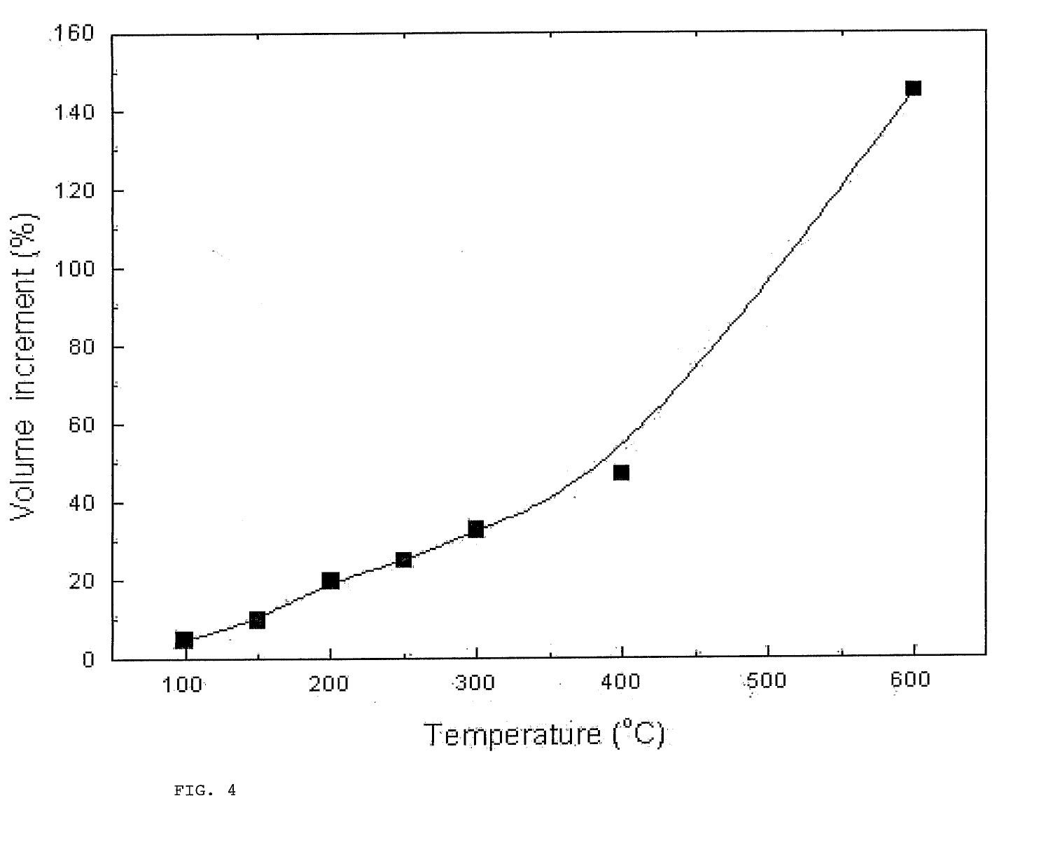

At a temperature lower than 150° C., the expansion ratio is as low as 10% or less, while it is above 20% and 40% at a temperature of 300° C. and 400° C., respectively. This suggests that the expansion ratio is in proportion to temperature. In addition, it is observed that rapid expansion occurs within the first 30 minutes during the heat treatment and expansion is substantially completed within 60 minutes. The expanded volume increment (%) over a heating time of 60 minutes is shown as a function of temperature in FIG. 4. As can be seen from FIG. 4, the expansion ratio is about 140% at a heating temperature of 600° C.

Determination of Effect of Expansion Ratio upon Size Reduction Efficiency During Grinding of Flaky Graphite

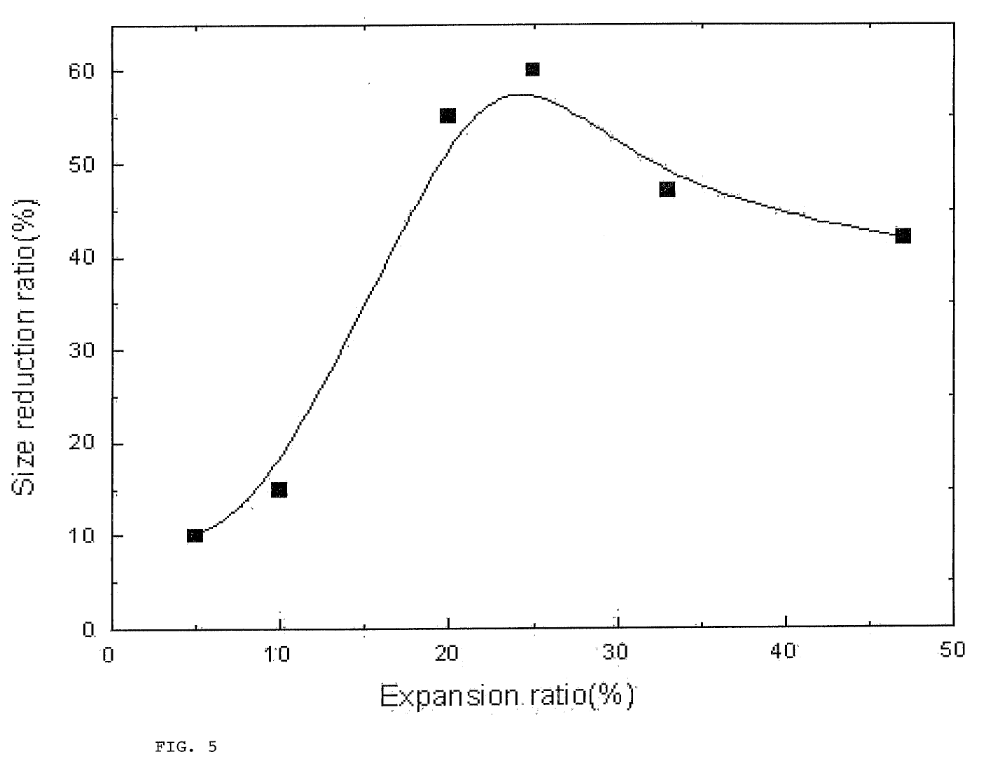

The effect of the expansion ratio upon the size reduction efficiency during the grinding of flaky graphite is determined in Examples 1-3 and Comparative Examples 1-4. The size reduction efficiency is measured as the yield of fine particles with a size of 3 μm or less. The results are shown in FIG. 5.

It can be seen that the yield of fine particles is relatively high when the expansion ratio is 20-40%, particularly 20-30%. As the expansion ratio increases above 40%, the yield of fine particles decreases. This is because the expanded flaky graphite absorbs grinding energy due to the over-expansion. The expanded flaky graphite may be further expanded by mechanical force while being ground into fine particles during the grinding operation. Therefore, to obtain ultrafine particles of flaky graphite in accordance with an embodiment of the present invention, it is required that the flaky graphite is subjected to low-expansion of 20-30% through the heat treatment so that it is expanded uniformly. Preferably, such a low-expansion is carried out to 20-40%, more preferably 20-30%.

Determination of Grinding Efficiency Depending on Slurry Concentration

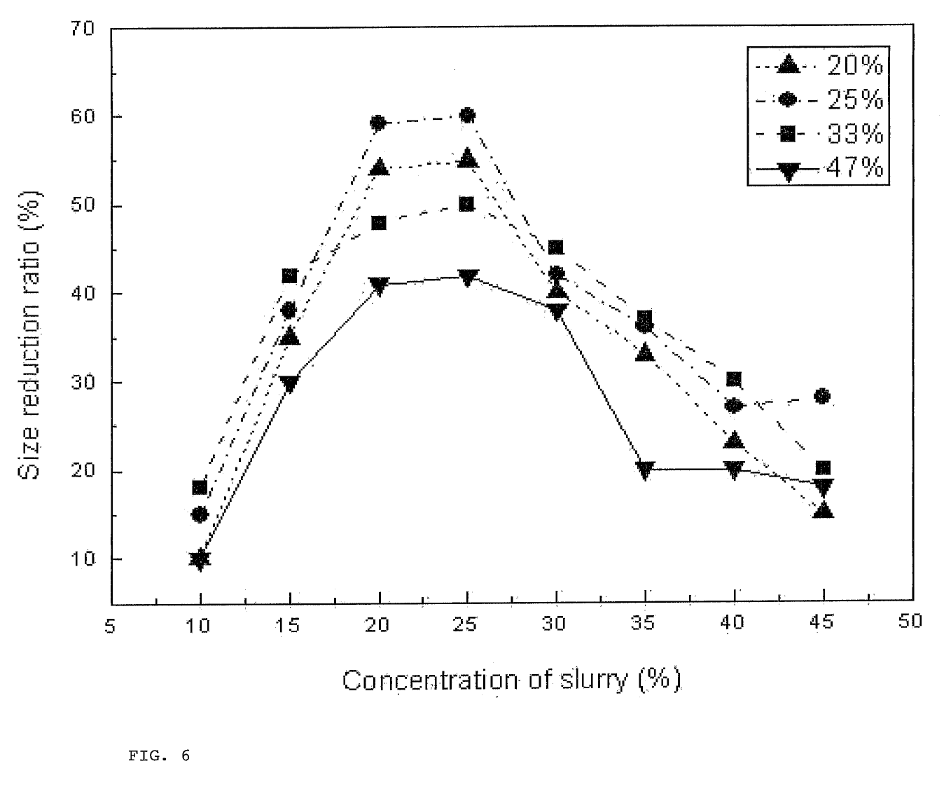

In the method disclosed herein, the surface area of flaky graphite is varied with the expansion ratio. The following test is carried out to determine the effect of the slurry concentration upon the slurry fluidity and grinding efficiency during the wet grinding operation. Each sample according to Examples 1-3 and Comparative Example 1 is adjusted to a slurry concentration of 10-45 wt % during the wet grinding operation to determine the effect of the slurry concentration upon the grinding efficiency. The grinding efficiency is measured as the yield of fine particles with a size of 3 μm or less. The results are shown in FIG. 6. As can be seen from FIG. 6, the highest grinding efficiency is obtained when the wet grinding is carried out under a slurry concentration of 25 wt % of flaky graphite with an expansion ratio of 25%. Therefore, the optimum slurry concentration is preferably 20-28%, more preferably 25 wt % to obtain ultrafine particles of flaky graphite after the wet grinding.

Variations of Flaky Graphite Particles Depending on Grinding Time

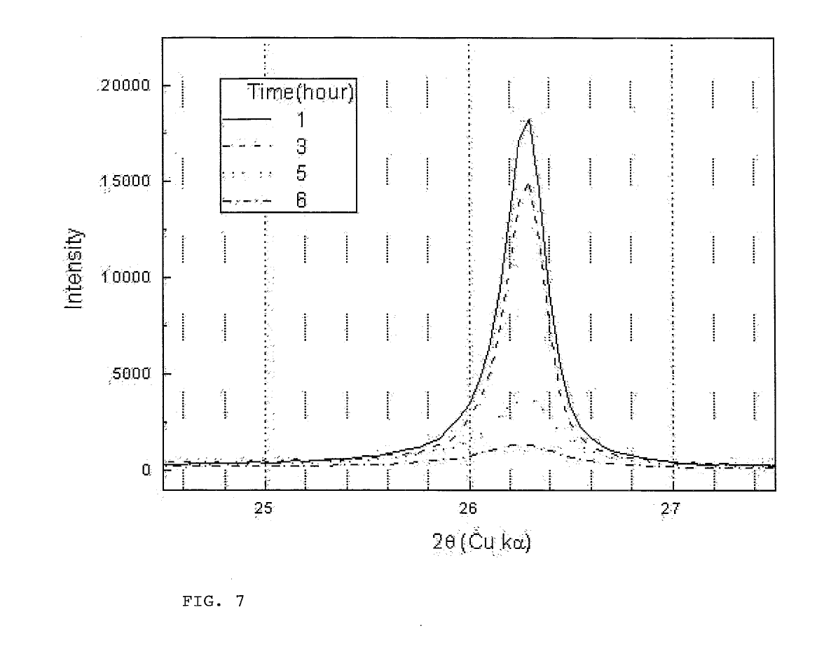

The wet grinding operation in Example 1 is carried out for a grinding time of 1, 3, 5 and 6 hours to observe the variations of crystallinity of flaky graphite particles depending on grinding time through X-ray diffraction (XRD). The results are shown in FIG. 7. As can be seen from FIG. 7, the variations of intensity suggest the variations crystallinity of flaky graphite particles. The intensity decreases as the size reduction proceeds. However, there is no change in d-value. Herein, d-value means 2θ value corresponding to X-axis. In other words, variations of the peak position (2θ value) depending on grinding time suggest variations of the interlayer distance in graphite. Therefore, it can be seen that there is no change in a layer unit. It can be also seen from the above results that expansion, grinding and exfoliation of graphite does not occur among the layers forming a stack but among the clusters substantially, according to the method for preparing ultrafine particles of flaky graphite disclosed herein. Herein, the stack means a unit formed from 10-20 layers, and the cluster means a unit formed from 10-20 stacks.

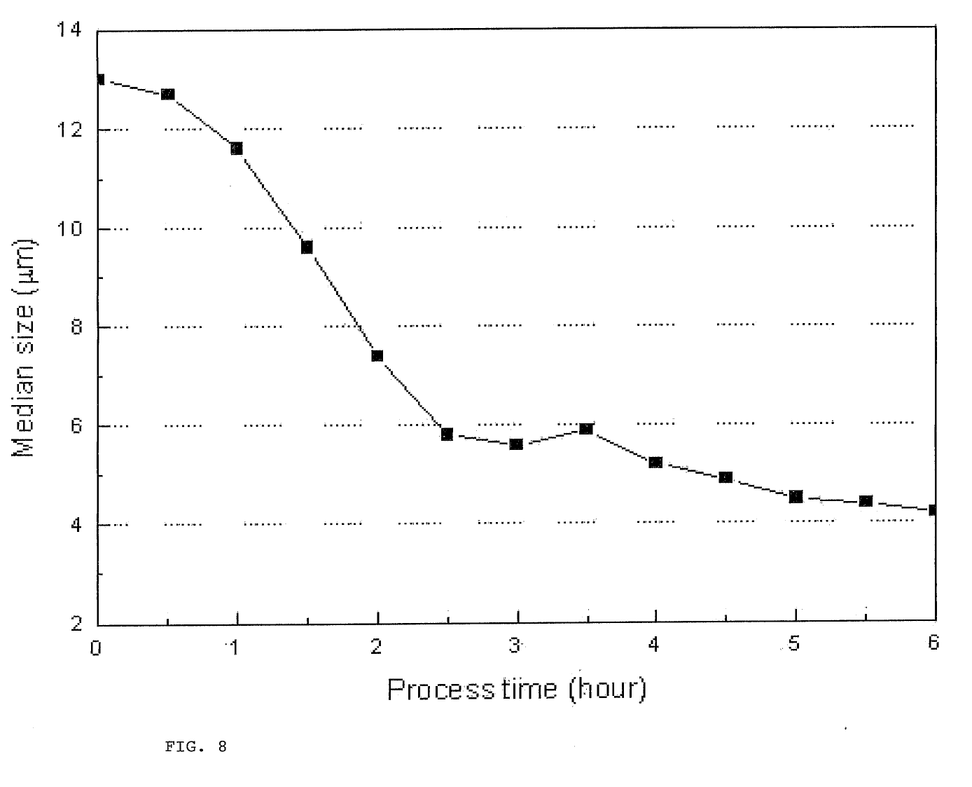

In addition, the wet grinding operation in Example 1 is carried out while varying the grinding time and variations of particles with time are observed. The results are shown in FIG. 8.

As can be seen from FIG. 8, the particle size decreases with time. Particularly, the particle size decreases at a relatively high rate within a period of 3 hours, and the rate is lowered after 3 hours. A slight increase in particle size appears at a time point of about 3.5 hours. It is thought that this does not result from an experimental error but from a substantial increase in particle size (i.e. expansion), as demonstrated by repeated experiments. Such expansion is caused by interlayer expansion of clusters partially exfoliated by the impact applied from the attrition mill.

The method disclosed herein uses an attrition mill so that flaky graphite is ground in a cluster unit. If a vibration mill is used, continuous impact will be applied to graphite particles via vibration, resulting in a collapse of the internal structure of flaky graphite. Therefore, it is preferred that an attrition mill is used.

SEM Analysis of Ultrafine Particles of Flaky Graphite

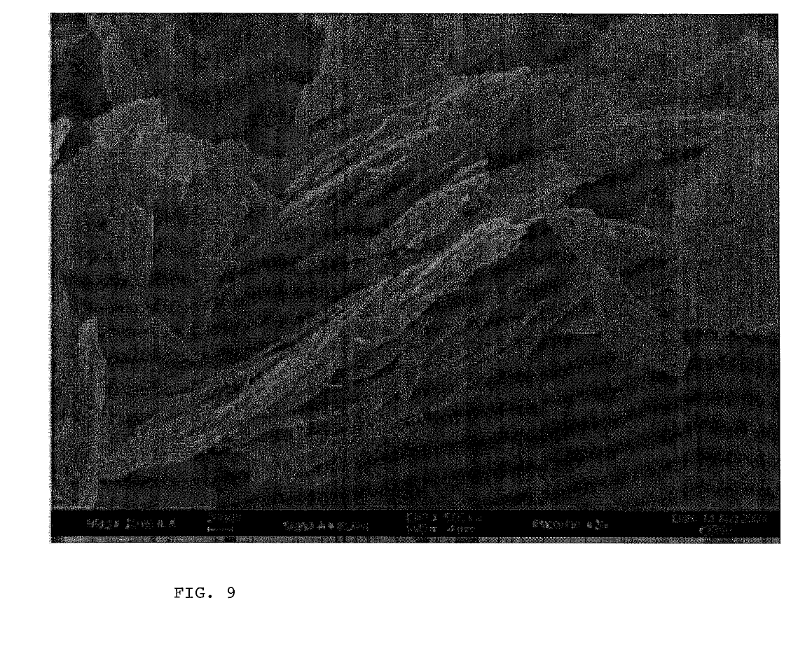

The ultrafine particles of flaky graphite obtained from Example 1 are observed through SEM. The result is shown in FIG. 9. As can be seen from the result of SEM analysis, the particles have a thickness of 30 nm and are expanded in a cluster unit. It can be also seen that there is no collapse in a layer unit.

Particle Size Analysis of Example 4

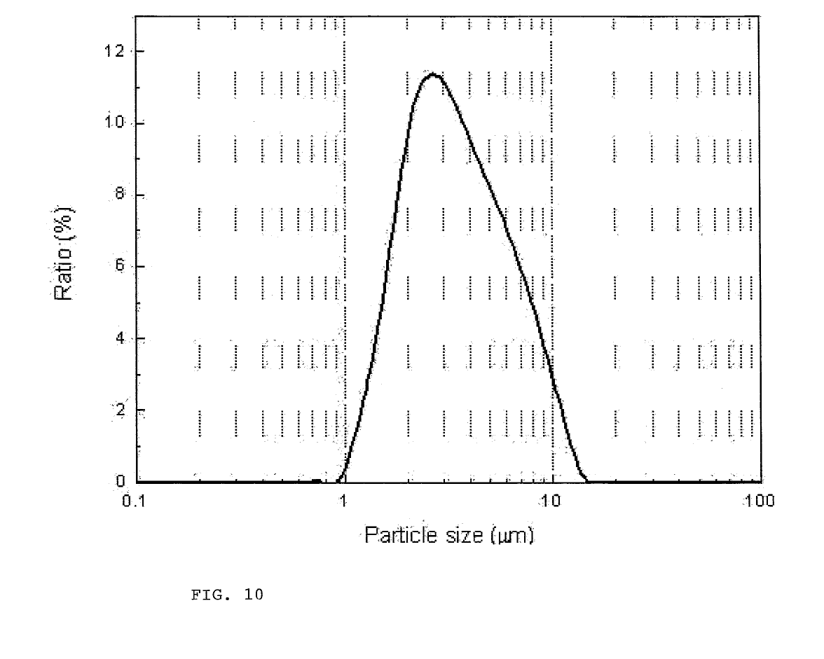

The particles obtained from Example 4 are analyzed to determine the particle size. The results are shown in FIG. 10. In general, grinding through a vibration mill provides fine particles of flaky graphite having a broader particle size distribution as compared to those particles ground through an attrition mill. As can be seen from FIG. 10, the method disclosed herein provides a relatively narrow particle size distribution.

TABLE 1

| | Heat Treatment | Slurry | |
|---|---|---|---|
| | Temperature | Concentration | Grinding Time |
| | (° C.) | (wt %) | (Hour) |
| Ex. 1 | 250 | 25 | 2 |
| Ex. 2 | 300 | 25 | 2 |
| Ex. 3 | 200 | 25 | 2 |
| Ex. 4 | 250 | 25 | 6 |
| Comp. Ex. 1 | 400 | 25 | 2 |
| Comp. Ex. 2 | 150 | 25 | 2 |
| Comp. Ex. 3 | 100 | 25 | 2 |
| Comp. Ex. 4 | 600 | 25 | 2 |

While the present invention has been described with respect to the specific embodiments, it will be apparent to those skilled in the art that various changes and modifications may be made without departing from the spirit and scope of the invention as defined in the following claims.

What is claimed is:

1. A method for preparing plate-like ultrafine particles of flaky graphite having an average graphite plate diameter of 3-5 μm and a graphite plate thickness of 20-60 nm, comprising:
grinding natural flaky graphite to control the particle size to 5-15 μm;
dipping the ground flaky graphite into an aqueous solution containing an acid and an oxidizing agent, followed by washing and drying, to form a graphite intercalation compound in the ground flaky graphite;
carrying out gasification of the graphite intercalation compound via low-temperature heat treatment to expand the flaky graphite to 20-30%; and
carrying out wet grinding of the expanded flaky graphite at a slurry concentration of 20-28 wt %.

2. The method for preparing plate-like ultrafine particles of flaky graphite according to claim 1, wherein said low-temperature heat treatment is carried out at 200-300° C. for 60-200 minutes.

3. The method for preparing plate-like ultrafine particles of flaky graphite according to claim 1, wherein said wet grinding is carried out by attrition milling.

4. The method for preparing plate-like ultrafine particles of flaky graphite according to claim 3, wherein said attrition milling is carried out using the flaky graphite, balls and water in a weight ratio of flaky graphite:balls: water of 1:45-65:3-5.

5. The method for preparing plate-like ultrafine particles of flaky graphite according to claim 4, wherein said attrition milling is carried out at 500-700 rpm for 2-6 hours.

6. The method for preparing plate-like ultrafine particles of flaky graphite according to claim 1, wherein the flaky graphite is expanded in a cluster unit by said low-temperature heat treatment.

7. The method for preparing plate-like ultrafine particles of flaky graphite according to claim 1, wherein the acid is sulfuric acid, the oxidizing agent is hydrogen peroxide, and the aqueous solution comprises 3-10 parts by weight of hydrogen peroxide and 5-50 parts by weight of water based on 100 parts by weight of sulfuric acid.
